(19) United States
(12) Patent Application Publication
(10) Pub. No.: US 2022/0206567 A1
(43) Pub. Date: Jun. 30, 2022

(54) METHOD AND APPARATUS FOR CONTROLLING VEHICLE DISPLAY SCREEN, AND STORAGE MEDIUM

(71) Applicant: Shanghai SenseTime Lingang Intelligent Technology Co., Ltd., Shanghai (CN)

(72) Inventors: Haiyang Zou, Shanghai (CN); Jun Wu, Shanghai (CN); Yiqing Fan, Shanghai (CN); Ying Tao, Shanghai (CN); Liang Xu, Shanghai (CN)

(21) Appl. No.: 17/680,376

(22) Filed: Feb. 25, 2022

Related U.S. Application Data
(63) Continuation of application No. PCT/CN2021/109821, filed on Jul. 30, 2021.

(30) Foreign Application Priority Data
Dec. 31, 2020 (CN) 202011632094.6

(51) Int. Cl. G06F 3/01; G06T 7/70; G06F 3/147

(52) U.S. Cl. CPC G06F 3/012; G06T 7/70; G06T 2207/30268; G06T 2207/30201; G06F 3/147

(57) ABSTRACT

A method and apparatus for controlling vehicle display screen, and a storage medium are provided. The method includes that: image information of an occupant in a vehicle cabin is acquired; a rotation angle of a target part of the occupant is detected based on the image information, the target part being head, face or eyes; and in response to determining, according to the rotation angle of the target part, that the target part turns to a vehicle display screen in the vehicle cabin, the vehicle display screen is controlled to be lit up.

### CROSS-REFERENCE TO RELATED APPLICATIONS

This is a continuation of International Patent Application No. PCT/CN2021/109821, filed on Jul. 30, 2021, which claims priority to Chinese patent application No. 202011632094.6, filed to the China National Intellectual Property Administration on Dec. 31, 2020 and entitled “Method and Apparatus For Controlling Vehicle Display Screen, Electronic Device and Storage Medium”. The disclosures of International Patent Application No. PCT/CN2021/109821 and Chinese patent application No. 202011632094.6 are hereby incorporated by reference in their entireties.

### BACKGROUND

Man-machine interaction technology is a core technology in the development of automobile industry. The man-machine interaction of a vehicle can bring convenience to the driver and make the vehicle cabin more intelligent. At present, man-machine interaction programs of most of the vehicles are installed in a center console area, and the driver may wake up a screen by touching it to interact with the screen.

### SUMMARY

The disclosure relates to the field of vehicle technology, and in particular to a method and apparatus for controlling vehicle display screen, and a storage medium.

The disclosure provides a technical solution for control of a vehicle display screen.

According to an aspect of the disclosure, a method for controlling vehicle display screen is provided, which includes the following operations.

Image information of an occupant in a vehicle cabin is acquired.

A rotation angle of a target part of the occupant is detected based on the image information. The target part is head, face or eyes.

In response to determining, according to the rotation angle of the target part, that the target part turns to a vehicle display screen in the vehicle cabin, the vehicle display screen is controlled to be lit up.

According to an aspect of the disclosure, an apparatus for controlling vehicle display screen is provided. The apparatus includes one or more processors, and a memory for storing executable instructions.

The one or more processors are configured to call the executable instructions stored in the memory to: acquire image information of an occupant in a vehicle cabin; detect a rotation angle of a target part of the occupant based on the image information, the target part being head, face or eyes; and in response to determining, according to the rotation angle of the target part, that the target part turns to a vehicle display screen in the vehicle cabin, control the vehicle display screen to be lit up.

According to an aspect of the disclosure, there is provided a non-transitory computer-readable storage medium having stored therein computer program instructions which, when being executed by a processor, cause the processor to implement the steps of: acquiring image information of an occupant in a vehicle cabin; detecting a rotation angle of a target part of the occupant based on the image information, the target part being head, face or eyes; and in response to determining, according to the rotation angle of the target part, that the target part turns to a vehicle display screen in the vehicle cabin, controlling the vehicle display screen to be lit up.

It is to be understood that the above general descriptions and detailed descriptions below are only exemplary and explanatory and not intended to limit the disclosure.

Other features and aspects of the disclosure will become clear as exemplary embodiments are detailed below with reference to the accompanying drawings.

### BRIEF DESCRIPTION OF THE DRAWINGS

The accompanying drawings, which are incorporated in and constitute a part of this specification, illustrate embodiments consistent with the disclosure and, together with the specification, serve to illustrate the technical solutions of the disclosure.

FIG. 1 illustrates a flowchart of a method for controlling vehicle display screen according to an embodiment of the disclosure.

FIG. 2 illustrates a schematic diagram of different preset yaw angle ranges corresponding to different horizontal distances between a seat and a vehicle display screen according to an embodiment of the disclosure.

FIG. 3 illustrates a block diagram of an apparatus for controlling vehicle display screen according to an embodiment of the disclosure.

FIG. 4 illustrates a block diagram of an electronic device 800 according to an embodiment of the disclosure.

FIG. 5 illustrates a block diagram of an electronic device 1900 according to an embodiment of the disclosure.

### DETAILED DESCRIPTION

Each exemplary embodiment, feature and aspect of the disclosure will be described below with reference to the drawings in detail. The same reference signs in the drawings represent components with the same or similar functions. Although various aspects of the embodiments are shown in the drawings, the drawings are not required to be drawn to scale, unless otherwise specified.

The term “exemplary” used herein means “as an example, embodiment or illustration”. Herein, any embodiment described as “exemplary” should not be construed as being better than or preferred over other embodiments.

In the application, the term “and/or” is only used to describe an association relationship of associated objects and represents that three relationships may exist. For example, A and/or B may represent three conditions: i.e., independent existence of A, existence of both A and B and independent existence of B. In addition, the term “at least one” in the application represents any one of multiple or any combination of at least two of multiple. For example, including at least one of A, B or C may represent including any one or more elements selected from a group consist of A, B and C.

In addition, for describing the disclosure better, many specific details are presented in the following detailed description. It will be understood by those skilled in the art that the disclosure may still be implemented even without some specific details. In some examples, methods, means, components and circuits known very well to those skilled in the art are not described in detail, to highlight the subject-matter of the disclosure.

At present, man-machine interaction programs of most of the vehicles are installed in a center console area, and the driver may wake up a screen by touching it to interact with the screen. Such interaction distracts the driver's attention to some extent by tapping the screen, which may easily cause potential safety hazards.

In the embodiments of the disclosure, image information of an occupant in a vehicle cabin is acquired, a rotation angle of a target part of the occupant is detected based on the image information, and in response to determining that the target part turns to a vehicle display screen in the vehicle cabin according to the rotation angle of the target part, the vehicle display screen is controlled to be lit up. The vehicle display screen can be controlled to be lit up by means of the rotation of the target part of the occupant without waking up the vehicle display screen through manual touch of the occupant, thereby improving the convenience of control of the vehicle display screen, and helping to improve driving safety.

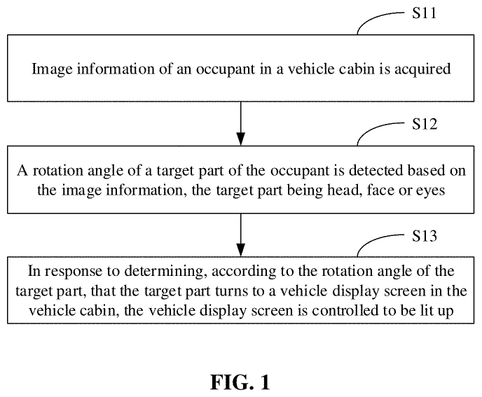

FIG. 1 illustrates a flowchart of a method for controlling vehicle display screen according to an embodiment of the disclosure. In a possible implementation, the method for controlling vehicle display screen may be executable by a terminal device or a server or other processing devices. The terminal device may be a vehicle device, User Equipment (UE), a mobile device, a user terminal, a terminal, a cell phone, a cordless phone, a Personal Digital Assistant (PDA), a handheld device, a computing device, a wearable device and the like. The vehicle device may be a vehicle terminal, a domain controller or a processor in the vehicle cabin, and may also be a host for processing data, such as images, in a Driver Monitor System (DMS) or an Occupant Monitoring System (OMS). In some possible implementations, the method for controlling vehicle display screen may be implemented by means of a processor calling a computer-readable instruction stored in a memory. As illustrated in FIG. 1, the method for controlling vehicle display screen may include operations S11 to S13.

At S11, image information of an occupant in a vehicle cabin is acquired.

At S12, a rotation angle of a target part of the occupant is detected based on the image information. The target part is head, face or eyes.

At S13, in response to determining that the target part turns to a vehicle display screen in the vehicle cabin according to the rotation angle of the target part, the vehicle display screen is controlled to be lit up.

The method for controlling vehicle display screen provided in the embodiment of the disclosure may be applied to various types of transports equipped with the vehicle display screen. For example, the transports may be vehicles, ships or airplanes used for carrying people or cargo. The vehicles may be private cars or commercial vehicles. For example, the commercial vehicles may be a shared car, an online taxi, a taxi, a bus, a school bus, a long-distance truck, a short-distance truck, an intercity bus, an interurban bus, a train, a subway, a streetcar, etc.

In a possible implementation, the image information of the occupant in the vehicle cabin may be acquired through a camera arranged in the vehicle cabin. The image information may be a video stream, an image, an image sequence, etc., which is not limited herein. For example, the camera arranged in the vehicle cabin may include a DMS camera, an OMS camera, etc. For example, the image information of the driver may be acquired through the DMS camera, and the image information of the occupant except the driver may be acquired through the OMS camera. The DMS camera may also perform other detections for the driver, such as fatigue detection, attention detection, etc. The OMS camera may also perform other detections for the occupant, such as the detection of occupant attributes (for example, at least one of age, gender, emotional state, physical state, etc.), and the detection of words and actions of the occupant. The camera arranged in the vehicle cabin may also include a common camera without other detection functions. In an implementation, the image information of the occupant in the vehicle cabin may also be acquired through the common camera. As an example of the implementation, the image information of the occupant in the vehicle cabin may be acquired in real time through the camera arranged in the vehicle cabin, so the rotation of the target part of the occupant can be detected in time based on the image information acquired in real time.

In the embodiments of the disclosure, the number of vehicle display screens in the vehicle cabin may be one or more than two. When the number of vehicle display screens in the vehicle cabin is more than two, the method for controlling vehicle display screen provided by the embodiment of the disclosure may be implemented for each vehicle display screen in the vehicle cabin. The method for controlling vehicle display screen may also be implemented only for part of the vehicle display screens in the vehicle cabin, which is no limited herein. The vehicle display screen may be any display screen arranged in the vehicle cabin. For example, the vehicle display screen may be a center console screen, an instrument panel, an A-pillar display screen, a rear display screen for passengers, etc.

In the embodiments of the disclosure, the target part is a part of the occupant's body for rotation angle detection. In the embodiments of the disclosure, the rotation angle of the target part of the occupant may be detected based on one or more images in the image information of the occupant in the vehicle cabin. For example, a neural network for detecting the rotation angle of the target part may be pre-trained. After the neural network is trained, at least one image in the image information is input into the neural network, and the rotation angle of the target part of the occupant is acquired through the neural network. For another example, a function for determining the rotation angle of the target part may be designed in advance, and the rotation angle of the target part corresponding to the image information is acquired through the function designed in advance.

In the embodiments of the disclosure, an orientation of the target part may be determined according to the rotation angle of the target part. In a possible implementation, if it is determined according to the rotation angle of the target part that the orientation of the target part changes from not facing the vehicle display screen to facing the vehicle display screen, it may be determined that the target part turns to the vehicle display screen. In the implementation, the vehicle display screen may be controlled to be lit up when the orientation of the target part changes and the target part is currently facing the vehicle display screen. In another possible implementation, if it is determined according to the rotation angle of the target part that the current orientation of the target part is toward the vehicle display screen, it may be determined that the target part turns to the vehicle display screen. In the implementation, regardless of whether the orientation of the target part changes, the vehicle display screen may be controlled to be lit up in response to the current orientation of the target part being toward the vehicle display screen.

In the embodiments of the disclosure, if the vehicle display screen is in an off state, the vehicle display screen may be woken up by controlling it to be lit up, so that the vehicle display screen switches from the off state to an on state. If the vehicle display screen is in the on state, the vehicle display screen may be controlled to keep the on state or increase the brightness by controlling it to be lit up. In a possible implementation, when the vehicle display screen is in the on state, the brightness of the vehicle display screen may be adjusted automatically according to the ambient brightness.

In the embodiments of the disclosure, the occupant may include any person in the vehicle cabin. In a possible implementation, the occupant includes the driver. In the implementation, the image information of the driver in the vehicle cabin (for example, image information of the driving area) is acquired, the rotation angle of the target part of the driver is detected based on the image information of the driver, and in response to determining that the target part turns to the vehicle display screen in the vehicle cabin according to the rotation angle of the target part, the vehicle display screen is controlled to be lit up. In this way, the vehicle display screen can be controlled to be lit up by means of the rotation of the target part of the driver without waking up the vehicle display screen through manual touch of the driver, that is, without the driver having to free up his occupied hands, thus improving the convenience of control of the vehicle display screen, and helping to improve driving safety. In another possible implementation, the occupant may also include any passenger except the driver.

In a possible implementation, the operation that in response to determining that the target part turns to the vehicle display screen in the vehicle cabin according to the rotation angle of the target part, the vehicle display screen is controlled to be lit up may include that: in response to determining that the rotating angle of the target part belongs to a preset angle range according to the rotation angle of the target part, the vehicle display screen is controlled to be lit up. A direction toward the front of the vehicle is used as a reference direction for the rotation angle of the target part. In the implementation, when the target part is toward the front of the vehicle (i.e. toward the straight ahead), that is, when orientation of the target part is the same as the direction of the front of the vehicle, the rotation angle of the target part may be 0. In the implementation, when it is determined that the rotation angle of the target part belongs to the preset angle range according to the rotation angle of the target part, it may be determined that the target part turns to the vehicle display screen in the vehicle cabin. In the implementation, the vehicle display screen is controlled to be lit up in response to determining that the rotation angle of the target part belongs to the preset angle range according to the rotation angle of the target part, and the accurate control of the vehicle display screen can be realized.

As an example of the implementation, the rotation angle of the target part includes a yaw angle of the target part and/or a pitch angle of the target part, and the preset angle range includes a preset yaw angle range and/or a preset pitch angle range. The operation that in response to determining that the rotating angle of the target part belongs to the preset angle range according to the rotation angle of the target part, the vehicle display screen is controlled to be lit up may include that: in response to determining, according to the rotation angle of the target part, that the yaw angle of the target part belongs to the preset yaw angle range and/or the pitch angle of the target part belongs to the preset pitch angle range, the vehicle display screen is controlled to be lit up.

In an example, the rotation angle of the target part includes the yaw angle of the target part and the pitch angle of the target part, and the preset angle range includes the preset yaw angle range and the preset pitch angle range. The operation that in response to determining that the rotating angle of the target part belongs to the preset angle range according to the rotation angle of the target part, the vehicle display screen is controlled to be lit up may include that: in response to determining, according to the rotation angle of the target part, that the yaw angle of the target part belongs to the preset yaw angle range and the pitch angle of the target part belongs to the preset pitch angle range, the vehicle display screen is controlled to be lit up. For example, the preset yaw angle range is [α₁, α₂], and the preset pitch angle range is [γ₁, γ₂], where α₁<α₂, and γ₁<γ₂. It is assumed that the yaw angle of the target part is αᵤ and the pitch angle of the target part is γᵤ. If α₁≤αᵤ≤α₂ and γ₁≤γᵤ≤γ₂, the vehicle display screen may be controlled to be lit up. The vehicle display screen may not be controlled to be lit up if αᵤ<α₁, αᵤ>α₂, γᵤ<γ₁, or γᵤ>γ₂. For example, the occupant includes the driver, and when the target part of the driver turns to the right rear-view mirror, αᵤ>α₂. In this case, the vehicle display screen is not controlled to be lit up.

In another example, the rotation angle of the target part includes the yaw angle of the target part, and the preset angle range includes the preset yaw angle range. The operation that in response to determining that the rotating angle of the target part belongs to the preset angle range according to the rotation angle of the target part, the vehicle display screen is controlled to be lit up may include that: in response to determining, according to the rotation angle of the target part, that the yaw angle of the target part belongs to the preset yaw angle range, the vehicle display screen is controlled to be lit up. For example, the preset yaw angle range is [α₁, α₂], and the yaw angle of the target part is αᵤ. If α₁≤αᵤ≤α₂, the vehicle display screen may be controlled to be lit up. If αᵤ<α₁ or αᵤ>α₂, the vehicle display screen may not be controlled to be lit up.

In another example, the rotation angle of the target part includes the pitch angle of the target part, and the preset angle range includes the preset pitch angle range. The operation that in response to determining that the rotating angle of the target part belongs to the preset angle range according to the rotation angle of the target part, the vehicle display screen is controlled to be lit up may include that: in response to determining, according to the rotation angle of the target part, that the pitch angle of the target part belongs to the preset pitch angle range, the vehicle display screen is controlled to be lit up. For example, the preset pitch angle range is [γ₁, γ₂], and the pitch angle of the target part is γᵤ. If γ₁≤γᵤ≤γ₂, the vehicle display screen may be controlled to be lit up. If γᵤ<γ₁ or γᵤ>γ₂, the vehicle display screen may not be controlled to be lit up.

In the example, in response to determining, according to the rotation angle of the target part, that the yaw angle of the target part belongs to the preset yaw angle range and/or the pitch angle of the target part belongs to the preset pitch angle range, the vehicle display screen is controlled to be lit up. In this way, the vehicle display screen can be controlled to be lit up accurately by means of the rotation of the target part of the occupant.

As an example of the implementation, the preset angle range includes a preset angle range corresponding to the occupant. The operation that in response to determining that the rotating angle of the target part belongs to the preset angle range according to the rotation angle of the target part, the vehicle display screen is controlled to be lit up may include that: in response to determining, according to the rotation angle of the target part, that the rotation angle of the target part belongs to the preset angle range corresponding to the occupant, the vehicle display screen is controlled to be lit up. In the example, for any occupant, the vehicle display screen may be controlled to be lit up based on the preset angle range corresponding to the occupant and the rotation of the target part of the occupant. In the example, different occupants may correspond to different preset angle ranges, so the accurate control of the vehicle display screen can be realized respectively for different occupants.

In an example, before the operation that in response to determining that the rotation angle of the target part belongs to the preset angle range corresponding to the occupant according to the rotation angle of the target part, the vehicle display screen is controlled to be lit up, the method may also include that: the preset angle range corresponding to the occupant is determined according to position information of the occupant. In the example, the position information of the occupant may be information that can represent a position of at least one part of the occupant. The at least one part may include the target part or other parts except the target part, which is not limited herein. In the example, the preset angle range corresponding to the occupant is determined according to the position information of the occupant, and the vehicle display screen is controlled for the occupant based on the determined preset angle range corresponding to the occupant, thereby improving the accuracy of control of the vehicle display screen.

In an example, the position information of the occupant includes the position information of the target part of the occupant. Determining the preset angle range corresponding to the occupant according to the position information of the occupant may include that: the preset angle range corresponding to the occupant is determined according to the position information of the target part of the occupant. In this example, the position information of the target part of the occupant may be represented by at least one of a coordinate of the target part in a world coordinate system, a coordinate of the target part in an image coordinate system, or the position of the target part relative to a first reference position. The image coordinate system represents the image coordinate system corresponding to the image information. The first reference position may be vehicle roof, steering wheel or other fixed positions in the vehicle cabin. In this example, the preset angle range corresponding to the occupant is determined according to the position information of the target part of the occupant, and whether the target part turns to the vehicle display screen is determined based on the determined preset angle range corresponding to the occupant, to further control the vehicle display screen. Thus, the accuracy of control of the vehicle display screen can be further improved, and the experience of interacting with the vehicle display screen of the occupant can be improved.

For example, the preset angle range corresponding to the occupant includes a preset yaw angle range corresponding to the occupant and/or a preset pitch angle range corresponding to the occupant. Determining the preset angle range corresponding to the occupant according to the position information of the target part of the occupant may include that: the preset yaw angle range corresponding to the occupant is determined according to a horizontal distance between the target part of the occupant and the vehicle display screen; and/or, the preset pitch angle range corresponding to the occupant is determined according to a height of the target part of the occupant. In this example, the horizontal distance between the target part of the occupant and the vehicle display screen may represent a distance between the target part of the occupant and the vehicle display screen in a horizontal direction. The height of the target part of the occupant may be represented by at least one of a distance between the target part of the occupant and the top of the vehicle cabin, the coordinate of the target part of the occupant in the world coordinate system (such as the z coordinate), or the coordinate of the target part of the occupant in the image coordinate system, which is not limited herein. For example, the occupant with a smaller horizontal distance between the target part and the vehicle display screen may correspond to a larger preset yaw angle range, and the occupant with a larger horizontal distance between the target part and the vehicle display screen may correspond to a smaller preset yaw angle range. For another example, the occupant with a higher target part may correspond to a larger preset pitch angle range, and the occupant with a lower target part may correspond to a smaller preset pitch angle range. In this example, the preset yaw angle range corresponding to the occupant is determined according to the horizontal distance between the target part of the occupant and the vehicle display screen, and/or the preset pitch angle range corresponding to the occupant is determined according to the height of the target part of the occupant, thus the preset angle range corresponding to the occupant can be determined adaptively for the occupants with different heights or different seat position adjustment habits, thereby controlling a center control screen to be lit up more accurately and automatically.

For example, the rotation angle of the target part includes the yaw angle of the target part and the pitch angle of the target part, and the preset angle range corresponding to the occupant includes the preset yaw angle range corresponding to the occupant and the preset pitch angle range corresponding to the occupant. The operation that the preset angle range corresponding to the occupant is determined according to the position information of the target part of the occupant may include that: the preset yaw angle range corresponding to the occupant is determined according to the horizontal distance between the target part of the occupant and the vehicle display screen; and the preset pitch angle range corresponding to the occupant is determined according to the height of the target part of the occupant.

For another example, the rotation angle of the target part includes the yaw angle of the target part, and the preset angle range corresponding to the occupant includes the preset yaw angle range corresponding to the occupant. The operation that the preset angle range corresponding to the occupant is determined according to the position information of the target part of the occupant may include that: the preset yaw angle range corresponding to the occupant is determined according to the horizontal distance between the target part of the occupant and the vehicle display screen.

For another example, the rotation angle of the target part includes the pitch angle of the target part, and the preset angle range corresponding to the occupant includes the preset pitch angle range corresponding to the occupant. The operation that the preset angle range corresponding to the occupant is determined according to the position information of the target part of the occupant may include that: the preset pitch angle range corresponding to the occupant is determined according to the height of the target part of the occupant.

In other examples, the preset yaw angle range corresponding to the occupant may also be determined according to a horizontal distance between the target part of the occupant and the steering wheel or the instrument panel, which is not limited herein.

For example, before the preset angle range corresponding to the occupant is determined according to the position information of the target part of the occupant, the method may further include that: the position information of the target part of the occupant is determined according to the image information. In the example, the position information of the target part of the occupant is determined according to the image information, so that the position information of the target part of the occupant can be determined accurately based on the computer vision technology.

For another example, before the preset angle range corresponding to the occupant is determined according to the position information of the target part of the occupant, the method may further include that: the position information of the target part of the occupant is determined through a distance sensor.

In another example, the position information of the occupant includes position information of a seat of the occupant. The operation that the preset angle range corresponding to the occupant is determined according to the position information of the occupant may include that: the preset angle range corresponding to the occupant is determined according to the position information of the seat of the occupant. In the example, the position information of the seat of the occupant may be acquired from a Body Control Module (BCM), or the position information of the seat of the occupant may be determined according to the image information. In the example, the position information of the seat of the occupant may be represented by at least one of the position of the seat of the occupant relative to a second reference position, a coordinate of the seat of the occupant in the world coordinate system, or a coordinate of the seat of the occupant in the image coordinate system. The second reference position may be the steering wheel, the instrument panel, a floor of the vehicle cabin and other fixed positions in the vehicle cabin. The image coordinate system represents the image coordinate system corresponding to the image information. In the example, the preset angle range corresponding to the occupant is determined according to the position information of the seat of the occupant, so the preset angle range corresponding to the occupant can be determined by means of seat habits corresponding to different occupants. The accuracy of control of the vehicle display screen can be further improved by determining, based on the determined preset angle range corresponding to the occupant, whether the target part turns to the vehicle display screen to further control the vehicle display screen.

For example, the preset angle range corresponding to the occupant includes the preset yaw angle range corresponding to the occupant and/or the preset pitch angle range corresponding to the occupant. The operation that the preset angle range corresponding to the occupant is determined according to the position information of the seat of the occupant may include that: the preset yaw angle range corresponding to the occupant is determined according to a horizontal distance between the seat of the occupant and the vehicle display screen; and/or, the preset pitch angle range corresponding to the occupant is determined according to a height of the seat of the occupant. In the example, the horizontal distance between the seat of the occupant and the vehicle display screen may represent the distance between the seat of the occupant and the vehicle display screen in a horizontal direction. The height of the seat of the occupant may be represented by at least one of a distance between the seat of the occupant and the bottom of the vehicle cabin, a distance between the seat of the occupant and the top of the vehicle cabin, a coordinate of the seat of the occupant in the world coordinate system (such as the z coordinate), a coordinate of the seat of the occupant in the image coordinate system, etc., which is not limited herein. For example, the occupant whose seat is more forward may correspond to a larger preset yaw angle range, and the occupant whose seat is more rearward may correspond to a smaller preset yaw angle range. For another example, the occupant whose seat is higher may correspond to a larger preset pitch angle range, and the occupant whose seat is lower may correspond to a smaller preset pitch angle range. In the example, the preset yaw angle range corresponding to the occupant is determined according to the horizontal distance between the seat of the occupant and the vehicle display screen, and/or the preset pitch angle range corresponding to the occupant is determined according to the height of the seat of the occupant, so that the preset angle range corresponding to the occupant can be determined accurately.

For example, the rotation angle of the target part includes the yaw angle of the target part and the pitch angle of the target part, and the preset angle range corresponding to the occupant includes the preset yaw angle range corresponding to the occupant and the preset pitch angle range corresponding to the occupant. The operation that the preset angle range corresponding to the occupant is determined according to the position information of the seat of the occupant may include that: the preset yaw angle range corresponding to the occupant is determined according to the horizontal distance between the seat of the occupant and the vehicle display screen; and the preset pitch angle range corresponding to the occupant is determined according to the height of the seat of the occupant.

For another example, the rotation angle of the target part includes the yaw angle of the target part, and the preset angle range corresponding to the occupant includes the preset yaw angle range corresponding to the occupant. The operation that the preset angle range corresponding to the occupant is determined according to the position information of the seat of the occupant may include that: the preset yaw angle range corresponding to the occupant is determined according to the horizontal distance between the seat of the occupant and the vehicle display screen.

For another example, the rotation angle of the target part includes the pitch angle of the target part, and the preset angle range corresponding to the occupant includes the preset pitch angle range corresponding to the occupant. The operation that the preset angle range corresponding to the occupant is determined according to the position information of the seat of the occupant may include that: the preset pitch angle range corresponding to the occupant is determined according to the height of the seat of the occupant.

In other examples, the preset yaw angle range corresponding to the occupant may also be determined according to the horizontal distance between the seat of the occupant and the steering wheel or the instrument panel, which is not limited herein.

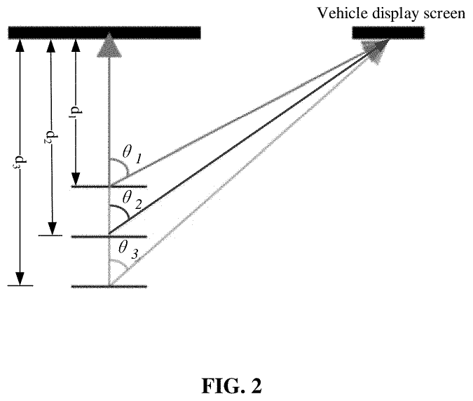

FIG. 2 is a schematic diagram illustrating different preset yaw angle ranges corresponding to different horizontal distances between a seat and a vehicle display screen according to an embodiment of the disclosure. For example, the horizontal distance d₁ corresponds to a preset first yaw angle range, the horizontal distance d₂ corresponds to a preset second yaw angle range, and the horizontal distance d₃ corresponds to a preset third yaw angle range. The median of the preset first yaw angle range is θ₁, the median of the preset second yaw angle range is θ₂, and the median of the preset third yaw angle range is θ₃.

In an example, the operation that the preset angle range corresponding to the occupant is determined according to the position information of the occupant may include that: the preset angle range corresponding to the occupant is determined according to the position information of the occupant and a correspondence between the position information and the preset angle range. In the example, the correspondence between the position information and the preset angle range may be preset. For example, a first coordinate interval corresponds to a preset first angle range, a second coordinate interval corresponds to a preset second angle range, and a third coordinate interval corresponds to a preset third angle range. If the position information of the occupant belongs to the first coordinate interval, it may be determined that the preset angle range corresponding to the occupant is the preset first angle range. If the position information of the occupant belongs to the second coordinate interval, it may be determined that the preset angle range corresponding to the occupant is the preset second angle range. If the position information of the occupant belongs to the third coordinate interval, it may be determined that the preset angle range corresponding to the occupant is the preset third angle range. In the example, the preset angle range corresponding to the occupant is determined according to the position information of the occupant and the correspondence between the position information and the preset angle range, so that the preset angle range corresponding to the occupant can be determined quickly.

In another example, the operation that the preset angle range corresponding to the occupant is determined according to the position information of the occupant may include that: the position information of the occupant is input into a pre-trained model, and the preset angle range corresponding to the occupant is output through the pre-trained model. In this example, a relationship between the position information and the preset angle range may be fitted through a model, that is, parameters of the model may be optimized by training the model. After the training of the model is completed, it may be used to determine the preset angle range corresponding to the position information of the occupant more flexibly.

In another example, a correspondence between face information and the preset angle range may be stored in advance. After an occupant is detected, the face information of the occupant may be acquired based on the image information, and the preset angle range corresponding to the occupant may be determined according to the face information of the occupant and the correspondence between the face information and the preset angle range. The face information may include at least one of identity information, a face image, a face feature, etc.

In an example, the method may further include the following operation. In response to detecting adjustment information of the seat of the occupant, the preset angle range corresponding to the occupant is re-determined according to the position information of the occupant after the seat is adjusted. In the example, if the adjustment information of the seat of the occupant is detected, the preset angle range corresponding to the occupant may be re-determined according to the position information of the target part of the occupant after the seat is adjusted or the position information of the seat of the occupant after adjustment. For example, the occupant includes the driver, and the driver may adjust the seat before starting to drive. If the adjustment information of the seat of the driver (namely the adjustment information of the main driver's seat) is detected, the preset angle range corresponding to the driver may be re-determined according to the position information of the target part of the driver after the seat is adjusted or the position information of the seat of the driver after adjustment. In the example, in response to detecting the adjustment information of the seat of the occupant, the preset angle range corresponding to the occupant is re-determined according to the position information of the occupant after the seat is adjusted, so that the accuracy of control of the vehicle display screen can be further improved.

In an example, the method may further include the following operation. In response to detecting an occupant in the vehicle cabin, the position information of the detected occupant is acquired, and the preset angle range corresponding to the detected occupant is determined according to the position information of the detected occupant. In the example, the occupant in the vehicle cabin may be detected based on the image information, and the occupant may also be detected through a seat sensor, which is not limited herein. For example, in response to detecting a new boarding occupant, position information of the new boarding occupant may be acquired, and the preset angle range corresponding to the new boarding occupant may be determined according to the position information of the new boarding occupant. In the example, in response to detecting an occupant in the vehicle cabin, the position information of the detected occupant is acquired, and the preset angle range corresponding to the detected occupant is determined according to the position information of the detected occupant. In this way, after the occupant gets in, the preset angle range corresponding to the occupant can be determined quickly, thus realizing the accurate control of the vehicle display screen.

In another possible implementation, the operation that in response to determining that the target part turns to the vehicle display screen in the vehicle cabin according to the rotation angle of the target part, the vehicle display screen is controlled to be lit up may include that: in response to determining that the target part faces the vehicle display screen after rotation according to an orientation of the target part before rotation and the rotation angle of the target part, the vehicle display screen is controlled to be lit up. The rotation angle of the target part takes the orientation of the target part before rotation as the reference direction. In the implementation, the rotation angle of the target part may represent the rotation angle of the target part relative to the orientation before rotation. In the implementation, the orientation of the target part after rotation may be determined according to the orientation of the target part before rotation and the rotation angle of the target part. If the orientation of the target part after rotation is toward the vehicle display screen, it may be determined that the target part turns to the vehicle display screen, so that the vehicle display screen may be controlled to be lit up. In the implementation, the vehicle display screen is controlled to be lit up in response to determining that the target part turns to the vehicle display screen after rotation according to the orientation of the target part before rotation and the rotation angle of the target part, so that the accurate control of the vehicle display screen can be realized.

In a possible implementation, the vehicle display screen may be controlled to be lit off in response to determining that the target part does not face the vehicle display screen according to the rotation angle of the target part and a duration of the target part not facing the vehicle display screen reaching a preset duration. According to the implementation, a power consumption of the vehicle display screen can be reduced, and an interference of the vehicle display screen to the occupant can be reduced.

In another possible implementation, the vehicle display screen may be controlled to be lit off in response to determining that the target part does not face the vehicle display screen according to the rotation angle of the target part. According to the implementation, the power consumption of the vehicle display screen can be reduced, and the interference of the vehicle display screen to the occupant can be reduced.

In the embodiments of the disclosure, the image information of the occupant in the vehicle cabin is acquired, the rotation angle of the target part of the occupant is detected based on the image information, and in response to determining, according to the rotation angle of the target part, that the target part turns to the vehicle display screen in the vehicle cabin, the vehicle display screen is controlled to be lit up. In this way, the vehicle display screen can be controlled to be lit up by means of the rotation of the target part of the occupant without waking up the vehicle display screen through manual touch of the occupant, thus improving convenience of control of the vehicle display screen, and helping to improve driving safety.

The method for controlling vehicle display screen provided by the embodiment of the disclosure is described below with reference to a specific application scenario. In the application scenario, the image information of the driver may be acquired through the DMS camera. After it is detected that the driver is seated, the preset yaw angle range and the preset pitch angle range corresponding to the driver may be determined according to the position information of the driver. The yaw angle and the pitch angle of the face of the driver may be detected based on the image information of the driver. If the yaw angle of the face of the driver belongs to the preset yaw angle range corresponding to the driver, and the pitch angle of the face of the driver belongs to the preset pitch angle range corresponding to the driver, the vehicle display screen may be controlled to be lit up. If the yaw angle of the face of the driver does not belong to the preset yaw angle range corresponding to the driver, or the pitch angle of the face of the driver does not belong to the preset pitch angle range corresponding to the driver, the vehicle display screen may not be woken up.

It should be understood that each method embodiment mentioned in the disclosure may be combined to form a combined embodiment without departing from principles and logics. For saving the space, elaborations are omitted in the disclosure. Those skilled in the art may understand that in the above methods, the specific execution sequence of the steps should be determined by their functions and possible internal logic.

In addition, the disclosure further provides an apparatus for controlling vehicle display screen, an electronic device, a computer-readable storage medium, and a program, which may be used to implement any method for controlling vehicle display screen provided in the disclosure. Reference may be made to the corresponding technical solution and effect in the method embodiment, which will not be repeated.

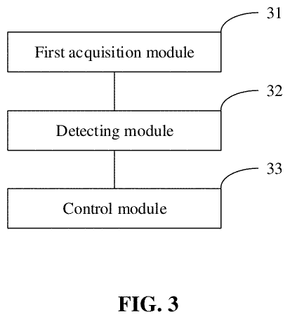

FIG. 3 illustrates a block diagram of an apparatus for controlling vehicle display screen according to an embodiment of the disclosure. As illustrated in FIG. 3, the apparatus for controlling vehicle display screen may include a first acquisition module 31, a detecting module 32 and a control module 33.

The first acquisition module 31 is configured to acquire image information of an occupant in a vehicle cabin.

The detecting module 32 is configured to detect a rotation angle of a target part of the occupant based on the image information. The target part is head, face or eyes.

The control module 33 is configured to, in response to determining that the target part turns to a vehicle display screen in the vehicle cabin according to the rotation angle of the target part, control the vehicle display screen to be lit up.

In a possible implementation, the control module 33 is configured to, in response to determining that the rotating angle of the target part belongs to a preset angle range according to the rotation angle of the target part, control the vehicle display screen to be lit up. The rotation angle of the target part takes a direction toward a front of the vehicle as a reference direction.

In a possible implementation, the rotation angle of the target part includes a yaw angle of the target part and/or a pitch angle of the target part, and the preset angle range includes a preset yaw angle range and/or a preset pitch angle range.

The control module 33 is configured to, in response to determining that the yaw angle of the target part belongs to the preset yaw angle range and/or the pitch angle of the target part belongs to the preset pitch angle range according to the rotation angle of the target part, control the vehicle display screen to be lit up.

In a possible implementation, the preset angle range includes a preset angle range corresponding to the occupant.

The control module 33 is configured to, in response to determining that the rotation angle of the target part belongs to the preset angle range corresponding to the occupant according to the rotation angle of the target part, control the vehicle display screen to be lit up.

In a possible implementation, the apparatus may further include a first determining module.

The first determining module is configured to determine the preset angle range corresponding to the occupant according to position information of the occupant.

In a possible implementation, the position information of the occupant includes position information of the target part of the occupant.

The first determining module is configured to determine the preset angle range corresponding to the occupant according to the position information of the target part of the occupant.

In a possible implementation, the preset angle range corresponding to the occupant includes the preset yaw angle range corresponding to the occupant and/or the preset pitch angle range corresponding to the occupant.

The first determining module is configured to: determine the preset yaw angle range corresponding to the occupant according to a horizontal distance between the target part of the occupant and the vehicle display screen; and/or, determine the preset pitch angle range corresponding to the occupant according to a height of the target part of the occupant.

In a possible implementation, the apparatus may further include a second determining module.

The second determining module is configured to determine the position information of the target part of the occupant according to the image information.

In a possible implementation, the position information of the occupant includes position information of a seat of the occupant.

The first determining module is configured to determine the preset angle range corresponding to the occupant according to the position information of the seat of the occupant.

In a possible implementation, the preset angle range corresponding to the occupant includes the preset yaw angle range corresponding to the occupant and/or the preset pitch angle range corresponding to the occupant.

The first determining module is configured to: determine the preset yaw angle range corresponding to the occupant according to the horizontal distance between the seat of the occupant and the vehicle display screen; and/or, determine the preset pitch angle range corresponding to the occupant according to the height of the seat of the occupant.

In a possible implementation, the first determining module is configured to determine the preset angle range corresponding to the occupant according to the position information of the occupant and a correspondence between the position information and a preset angle range.

In a possible implementation, the first determining module is configured to input the position information of the occupant into a pre-trained model, and output the preset angle range corresponding to the occupant through the pre-trained model.

In a possible implementation, the apparatus may further include a third determining module.

The third determining module is configured to, in response to detecting adjustment information of the seat of the occupant, re-determine the preset angle range corresponding to the occupant according to the position information of the occupant after the seat is adjusted.

In a possible implementation, the apparatus may further include a second acquisition module and a fourth determining module.

The second acquisition module is configured to, in response to detecting an occupant in the vehicle cabin, acquire the position information of the detected occupant.

The fourth determining module is configured to determine the preset angle range corresponding to the detected occupant according to the position information of the detected occupant.

In a possible implementation, the control module 33 is configured to, in response to determining that the target part faces the vehicle display screen after rotation according to an orientation of the target part before rotation and the rotation angle of the target part, control the vehicle display screen to be lit up. The rotation angle of the target part takes an orientation of the target part before rotation as the reference direction.

In a possible implementation, the occupant includes the driver.

In the embodiments of the disclosure, the image information of the occupant in the vehicle cabin is acquired, the rotation angle of the target part of the occupant is detected based on the image information, and in response to determining that the target part turns to the vehicle display screen in the vehicle cabin according to the rotation angle of the target part, the vehicle display screen is controlled to be lit up. In this way, the vehicle display screen can be controlled to be lit up by means of the rotation of the target part of the occupant without waking up the vehicle display screen through manual touch of the occupant, thereby improving the convenience of control of the vehicle display screen, and helping to improve driving safety.

In some embodiments, functions of or modules contained in the apparatus provided in the embodiments of the disclosure may be configured to perform the method described in the above method embodiments, the specific implementation and technical effects of which may refer to the description of the above method embodiments, and will not be described here for simplicity.

An embodiment of the disclosure further provides a computer-readable storage medium having stored therein a computer program instruction which, when being executed by a processor, causes the processor to implement the above method. The computer-readable storage medium may be a non-transitory computer-readable storage medium or may be a transitory computer-readable storage medium.

An embodiment of the disclosure further provides a computer program, which may include a computer-readable code. When the computer-readable code runs in an electronic device, the processor in the electronic device is configured to implement the above method.

An embodiment of the disclosure further provides a computer program product for storing a computer readable instruction. When the instruction is executed, the computer is caused to perform the operations of the method for controlling vehicle display screen according to any of the above embodiments.

An embodiment of the disclosure further provides an electronic device, which may include one or more processors and a memory for storing an executable instruction. The one or more processors are configured to call the executable instruction stored in the memory to execute the above method.

The electronic device may be provided as a terminal, a server or other forms of devices. The vehicle device may be the vehicle terminal, the domain controller or the processor in the vehicle cabin, and may also be the device host for performing data, such as images, processing in the DMS or the OMS.

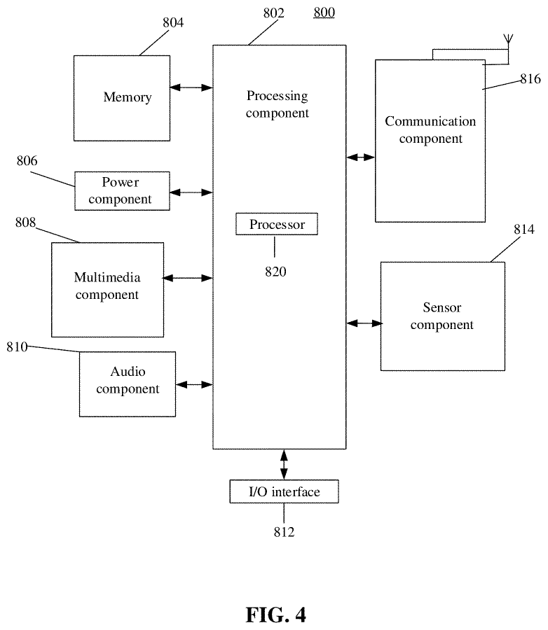

FIG. 4 shows a block diagram of an electronic device 800 according to an embodiment of the disclosure. For example, the electronic device 800 may be a mobile phone, a computer, a digital broadcast terminal, a messaging device, a gaming console, a tablet, a medical device, exercise equipment, a personal digital assistant and other terminals.

Referring to FIG. 4, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the steps in the above method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device 800. Examples of such data include instructions for any application programs or methods operated on the electronic device 800, contact data, phonebook data, messages, pictures, video, etc. The memory 804 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power component 806 provides power for various components of the electronic device 800. The power component 806 may include a power management system, one or more power supplies, and other components associated with generation, management and distribution of power for the electronic device 800.

The multimedia component 808 includes a screen providing an output interface between the electronic device 800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. In some embodiments, the multimedia component 808 includes a front camera and/or a rear camera. The front camera and/or the rear camera may receive external multimedia data when the electronic device 800 is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a Microphone (MIC), and the MIC is configured to receive an external audio signal when the electronic device 800 is in the operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 includes one or more sensors configured to provide status assessment in various aspects for the electronic device 800. For example, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 may access a communication-standard-based wireless network, such as a Wireless Fidelity (Wi-Fi) network, the 2nd-Generation (2G) mobile communication network, the 3rd-Generation (3G) mobile communication network, the 4th-Generation (4G) mobile communication network/Long-Term Evolution (LTE) for universal mobile communication technology, the 5th-Generation (5G) mobile communication network or a combination thereof. In an exemplary embodiment, the communication component 816 receives a broadcast signal or broadcast associated information from an external broadcast management system through a broadcast channel In an exemplary embodiment, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra-Wide Band (UWB) technology, a Bluetooth (BT) technology and another technology.

In an exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the above method.

In an exemplary embodiment, a nonvolatile computer-readable storage medium is also provided, for example, a memory 804 including a computer program instruction. The computer program instruction may be executed by a processor 820 of the electronic device 800 to execute the above method.

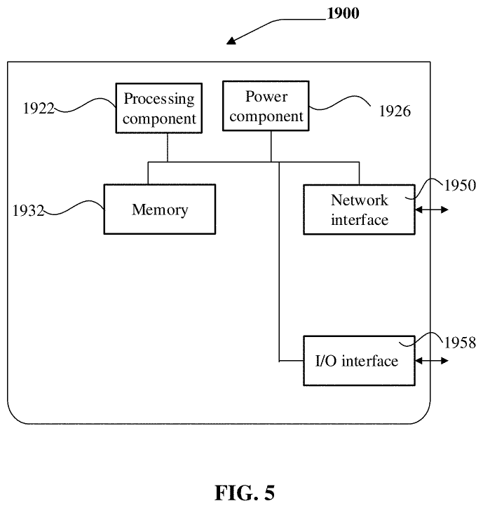

FIG. 5 shows a block diagram of an electronic device 1900 according to an embodiment of the disclosure. For example, the electronic device 1900 may be provided as a server. Referring to FIG. 5, the electronic device 1900 includes: a processing component 1922, which may further include one or more processors; and a memory resource represented by a memory 1932, configured to store an instruction executable by the processing component 1922, for example, an APP. The APP stored in the memory 1932 may include one or more than one module each corresponding to a set of instructions. In addition, the processing component 1922 is configured to execute the instruction to execute the above method.

The electronic device 1900 may further include a power component 1926 configured to execute power management for the electronic device 1900, a wired or wireless network interface 1950 configured to connect the electronic device 1900 to a network, and an I/O interface 1958. The electronic device 1900 may be operated based on an operating system stored in the memory 1932, for example, Windows Server™ Mac OS X™ launched by Apple Inc, Unix™, Linux™, FreeBSD™ or the like.

In an exemplary embodiment, a nonvolatile computer-readable storage medium is also provided, for example, a memory 1932 including a computer program instruction. The computer program instruction may be executed by a processing component 1922 of the electronic device 1900 to execute the above method.

The disclosure may be a system, a method and/or a computer program product. The computer program product may include a computer-readable storage medium having stored therein a computer-readable program instruction configured to enable a processor to implement each aspect of the disclosure.

The computer-readable storage medium may be a physical device capable of retaining and storing an instruction used by an instruction execution device. For example, the computer-readable storage medium may be, but not limited to, an electric storage device, a magnetic storage device, an optical storage device, an electromagnetic storage device, a semiconductor storage device or any appropriate combination thereof. More specifically, the computer-readable storage medium may include (non-exhaustive list) a portable computer disk, a hard disk, a RAM, a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described herein may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, optical fiber transmission, wireless transmission, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of the disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++, and a conventional procedural programming language such as “C” language or a similar programming language. The computer-readable program instruction may be completely executed in a computer of a user or partially executed in the computer of the user, may be executed as an independent software package, executed partially in the computer of the user and partially in a remote computer, or executed completely in the remote computer or a server. Under the condition that the remote computer is involved, the remote computer may be connected to the computer of the user through any type of network including a Local Area Network (LAN) or a Wide Area Network (WAN), or, may be connected to an external computer (for example, connected via the Internet through an Internet service provider). In some embodiments, an electronic circuit such as a programmable logic circuit, a Field Programmable Gate Array (FPGA) or a Programmable Logic Array (PLA) may be customized by use of state information of the computer-readable program instruction, and the electronic circuit may execute the computer-readable program instruction, thereby implementing each aspect of the disclosure.

Herein, each aspect of the disclosure is described with reference to flowcharts of the method, and/or block diagrams of the device (system) and computer program product according to the embodiments of the disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner. The computer-readable medium having stored therein instructions may include a product including instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer. The instructions are executed in the computer, the other programmable data processing device or the other device to realize the function/action specified in one or more blocks in the flowcharts and/or the block diagrams.

The flowcharts and block diagrams in the drawings illustrate probably implemented system architectures, functions and operations of the system, method and computer program product according to the embodiments of the disclosure. On this aspect, each block in the flowcharts or the block diagrams may represent a module, a program segment or part of instructions, and the module, the program segment or the part of the instructions includes one or more executable instructions configured to realize a specified logical function. In some alternative implementations, the functions marked in the blocks may also be realized in a sequence different from those marked in the drawings. For example, two continuous blocks may actually be executed substantially concurrently and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

The computer program product may be specifically realized by means of hardware, software or a combination thereof. In an optional embodiment, the computer program product is specifically embodied as a computer storage medium. In another optional embodiment, the computer program product is specifically embodied as software products, such as a Software Development Kit (SDK).

Embodiments of the disclosure have been described above. The above descriptions are exemplary, non-exhaustive and also not limited to the disclosed embodiments. Many modifications and variations are apparent to those of ordinary skill in the art without departing from the scope and spirit of the described embodiments of the disclosure. The terms used herein are selected to explain the principle and practical application of the embodiments or improvements to the technologies in the market best or enable others of ordinary skill in the art to understand each embodiment disclosed herein.

1. A method for controlling vehicle display screen, comprising:
acquiring image information of an occupant in a vehicle cabin;
detecting a rotation angle of a target part of the occupant based on the image information, wherein the target part is head, face or eyes; and
in response to determining, according to the rotation angle of the target part, that the target part turns to a vehicle display screen in the vehicle cabin, controlling the vehicle display screen to be lit up.

2. The method of claim 1, wherein in response to determining, according to the rotation angle of the target part, that the target part turns to the vehicle display screen in the vehicle cabin, controlling the vehicle display screen to be lit up comprises:
in response to determining, according to the rotation angle of the target part, that the rotating angle of the target part belongs to a preset angle range, controlling the vehicle display screen to be lit up, wherein the rotation angle of the target part takes a direction toward a front of a vehicle as a reference direction.

3. The method of claim 2, wherein,
the rotation angle of the target part comprises at least one of a yaw angle of the target part or a pitch angle of the target part;
the preset angle range comprises at least one of a preset yaw angle range or a preset pitch angle range;
in response to determining, according to the rotation angle of the target part, that the rotating angle of the target part belongs to the preset angle range, controlling the vehicle display screen to be lit up comprises: in response to determining, according to the rotation angle of the target part, that at least one of the yaw angle of the target part belongs to the preset yaw angle range or the pitch angle of the target part belongs to the preset pitch angle range, controlling the vehicle display screen to be lit up.

4. The method of claim 2, wherein,
the preset angle range comprises a preset angle range corresponding to the occupant;
in response to determining, according to the rotation angle of the target part, that the rotating angle of the target part belongs to the preset angle range, controlling the vehicle display screen to be lit up comprises: in response to determining, according to the rotation angle of the target part, that the rotation angle of the target part belongs to the preset angle range corresponding to the occupant, controlling the vehicle display screen to be lit up.

5. The method of claim 4, wherein before in response to determining, according to the rotation angle of the target part, that the rotation angle of the target part belongs to the preset angle range corresponding to the occupant, controlling the vehicle display screen to be lit up, the method further comprising:
determining the preset angle range corresponding to the occupant according to position information of the occupant.

6. The method of claim 5, wherein,
the position information of the occupant comprises position information of the target part of the occupant;
determining the preset angle range corresponding to the occupant according to the position information of the occupant comprises: determining the preset angle range corresponding to the occupant according to the position information of the target part of the occupant.

7. The method of claim 6, wherein the preset angle range corresponding to the occupant comprises at least one of a preset yaw angle range corresponding to the occupant or a preset pitch angle range corresponding to the occupant;
determining the preset angle range corresponding to the occupant according to the position information of the target part of the occupant comprises at least one of:
determining the preset yaw angle range corresponding to the occupant according to a horizontal distance between the target part of the occupant and the vehicle display screen;
or,
determining the preset pitch angle range corresponding to the occupant according to a height of the target part of the occupant.

8. The method of claim 6, wherein before determining the preset angle range corresponding to the occupant according to the position information of the target part of the occupant, the method further comprising:
determining the position information of the target part of the occupant according to the image information.

9. The method of claim 5, wherein,
the position information of the occupant comprises position information of a seat of the occupant;
determining the preset angle range corresponding to the occupant according to the position information of the occupant comprises: determining the preset angle range corresponding to the occupant according to the position information of the seat of the occupant.

10. The method of claim 9, wherein the preset angle range corresponding to the occupant comprises at least one of a preset yaw angle range corresponding to the occupant or a preset pitch angle range corresponding to the occupant;
determining the preset angle range corresponding to the occupant according to the position information of the seat of the occupant comprises at least one of:
determining the preset yaw angle range corresponding to the occupant according to a horizontal distance between the seat of the occupant and the vehicle display screen;
or,
determining the preset pitch angle range corresponding to the occupant according to a height of the seat of the occupant.

11. The method of claim 5, wherein determining the preset angle range corresponding to the occupant according to the position information of the occupant comprises:
determining the preset angle range corresponding to the occupant according to the position information of the occupant and a correspondence between the position information and the preset angle range.

12. The method of claim 5, wherein determining the preset angle range corresponding to the occupant according to the position information of the occupant comprises:
inputting the position information of the occupant into a pre-trained model, and outputting the preset angle range corresponding to the occupant through the pre-trained model.

13. The method of claim 4, further comprising:
in response to detecting adjustment information of a seat of the occupant, re-determining the preset angle range corresponding to the occupant according to position information of the occupant after the seat is adjusted.

14. The method of claim 4, further comprising:
in response to detecting an occupant in the vehicle cabin, acquiring position information of the detected occupant; and
determining the preset angle range corresponding to the detected occupant according to the position information of the detected occupant.

15. The method of claim 1, wherein in response to determining, according to the rotation angle of the target part, that the target part turns to the vehicle display screen in the vehicle cabin, controlling the vehicle display screen to be lit up comprises:
in response to determining, according to an orientation of the target part before rotation and the rotation angle of the target part, that the target part is toward the vehicle display screen after rotation, controlling the vehicle display screen to be lit up, wherein the rotation angle of the target part takes the orientation of the target part before rotation as a reference direction.

16. The method of claim 1, wherein the occupant comprises a driver.

17. An apparatus for controlling vehicle display screen, comprising:
one or more processors; and
a memory for storing executable instructions;
wherein the one or more processors are configured to call the executable instructions stored in the memory to:
acquire image information of an occupant in a vehicle cabin;
detect a rotation angle of a target part of the occupant based on the image information, wherein the target part is head, face or eyes; and
in response to determining, according to the rotation angle of the target part, that the target part turns to a vehicle display screen in the vehicle cabin, control the vehicle display screen to be lit up.

18. The apparatus of claim 17, wherein the one or more processors are further configured to:
in response to determining, according to the rotation angle of the target part, that the rotating angle of the target part belongs to a preset angle range, control the vehicle display screen to be lit up, wherein the rotation angle of the target part takes a direction toward a front of a vehicle as a reference direction.

19. The apparatus of claim 18, wherein,
the rotation angle of the target part comprises at least one of a yaw angle of the target part or a pitch angle of the target part;
the preset angle range comprises at least one of a preset yaw angle range or a preset pitch angle range;
the one or more processors are further configured to: in response to determining, according to the rotation angle of the target part, that at least one of the yaw angle of the target part belongs to the preset yaw angle range or the pitch angle of the target part belongs to the preset pitch angle range, control the vehicle display screen to be lit up.

20. A non-transitory computer-readable storage medium having stored therein computer program instructions which, when being executed by a processor, cause the processor to implement the steps of:
acquiring image information of an occupant in a vehicle cabin;
detecting a rotation angle of a target part of the occupant based on the image information, wherein the target part is head, face or eyes; and
in response to determining, according to the rotation angle of the target part, that the target part turns to a vehicle display screen in the vehicle cabin, controlling the vehicle display screen to be lit up.
